(19) United States
(12) Patent Application Publication
(10) Pub. No.: US 2007/0171248 A1
(43) Pub. Date: Jul. 26, 2007

(54) Method and apparatus for compensating image skew and electro-photographic image froming apparatus incorporating the same

(75) Inventors: Soo-Young Kim, Seoul (KR); Heung-Sup Jeong, Suwon-si (KR); Se-Hyun Lyu, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/650,487

(22) Filed: Jan. 8, 2007

(30) Foreign Application Priority Data
Jan. 16, 2006 (KR) 10-2006-0004480

(51) Int. Cl. B41J 29/38

(52) U.S. Cl. 347/16

(57) ABSTRACT

A method and apparatus for compensating image skew and an electro-photographic image forming apparatus including the same are provided. Image skew of a toner image transferred onto a paper is compensated for by inclining a photosensitive medium onto which a light beam is scanned to be parallel to a scanning line of the light beam. A first inclination member including a first inclined surface facing upward and a second inclination member including a second inclined surface contacting and facing the first inclined surface are provided, wherein a position of a shaft of the photosensitive medium is adjusted by moving at least one of the first and second inclination members. Image skew of a toner image is sensed, and a photosensitive medium onto which a light beam is scanned is inclined to correspond to a scanning line skew of the light beam.

### CROSS-REFERENCE TO RELATED PATENT APPLICATIONS

This application claims the benefit under 35 U.S.C. §119(a) of Korean Patent Application No. 10-2006-0004480, filed Jan. 16, 2006, in the Korean Intellectual Property Office, the entire disclosure of which is hereby incorporated by reference.

### BACKGROUND OF THE INVENTION

1. Field of the Invention

The present invention relates to an electro-photographic image forming apparatus. More particularly, the present invention relates to a method and apparatus for compensating image skew and an image forming apparatus including the same.

2. Description of the Related Art

Traditional electro-photographic image forming apparatuses form a latent image by scanning light on a photosensitive medium charged with a predetermined potential, develop the latent image into a visible image using a developing agent such as toner, and print the developed image by transferring and fixing the image onto a piece of paper.

FIG. 1 illustrates skew of a scanning line and image skew caused thereby. Referring to FIG. 1, a light beam is scanned from a laser scanning unit (not shown) onto an outer circumference of a charged photosensitive medium 10 to form a latent image. The latent image is developed into a visible toner image using toner, and the toner image is transferred to a piece of paper P. A beam scanning line is designated to extend horizontally into the Y-direction, which corresponds to the direction of a virtual line Y1 along the photosensitive medium 10. However, due to tolerances of the laser scanning unit itself, or manufacturing tolerances of the laser scanning unit when mounting it into the electro-photographic image forming apparatus, a scanning line does not extend parallel to the Y-direction but is slightly inclined with respect to the photosensitive medium 10 as shown by solid line BL. This is referred to as scanning skew. When a light beam is scanned on the photosensitive medium 10 without scanning skew, as shown by virtual line Y1, a toner line which extends horizontally into the Y-direction, as shown by virtual line Y2, is formed on a piece of paper P proceeding in the Z-direction perpendicularly to the Y-direction. However, when a light beam is scanned with scanning skew, as shown by the solid line BL, toners developed along with the skewed scanning line BL are transferred not simultaneously but gradually on the piece of paper P, and a toner line TL inclined in the opposite direction of the scanning line BL is formed. This is referred to as image skew.

Image skew deteriorates printing quality by inclining the printing image. In particular, in an electro-photographic color image forming apparatus forming a color image by overlapping images of several colors, when scanning skew occurs in one or more light beams among a plurality of light beams corresponding to a plurality of colors, printing quality is significantly deteriorated due to bad color registration.

To compensate for scanning skew and thereby prevent image skew, a method of inclining the laser scanning unit is conventionally used. However, in many cases, it is difficult to incline the laser scanning unit and thus a new method of compensating for image skew is required.

### SUMMARY OF THE INVENTION

Exemplary embodiments of the present invention provide an image skew compensating apparatus for compensating image skew by inclining a photosensitive medium, an electro-photographic image forming apparatus including the same, and a method of compensating for image skew.

Exemplary embodiments of the present invention provide an image skew compensating apparatus for compensating for image skew of a toner image transferred onto paper by inclining a photosensitive medium onto which a light beam is scanned to be parallel to a scanning line of the light beam. The image skew compensating apparatus comprises a first inclination member comprising a first inclined surface facing upward, and a second inclination member comprising a second inclined surface contacting and facing the first inclined surface, wherein the position of a shaft of the photosensitive medium is adjusted by moving at least one of the first and second inclination members.

In an exemplary implementation, the image skew compensating apparatus that moves at least one of the first and second inclination members may include a motor and a screw that is extended from a rotation axis of the motor and inserted into at least one of the first and second inclination members, and move at least one of the first and second inclination members back and forth according to the rotation direction of the motor.

In an exemplary implementation, a sensor sensing image skew and a controller controlling driving of the motor based on signals sensed by the sensor may also be provided.

In an exemplary implementation, the second inclination member can support the shaft of the photosensitive medium.

In an exemplary implementation, the second inclination member can support one side of a developing unit in which the photosensitive medium is installed.

In an exemplary implementation, the second inclination member can support one side of a frame that links and supports a plurality of developing units, which respectively include a photosensitive medium.

In an exemplary implementation, a rise and fall of the photosensitive medium by moving at least one of the first and second inclination member can be within 1 mm.

In an exemplary implementation, a plurality of photosensitive mediums and a plurality of the image skew compensating apparatuses corresponding to the number of the photosensitive mediums can be included.

In an exemplary implementation, a toner image developed on the photosensitive medium can be directly transferred to paper.

In an exemplary implementation, a toner image developed on the photosensitive medium can be indirectly transferred to paper via an intermediate transfer medium.

Exemplary embodiments of the present invention provide a method of compensating for image skew. The method comprises sensing image skew of a toner image, and inclining a photosensitive medium onto which a light beam is scanned to correspond to scanning line skew of the light beam.

In an exemplary implementation, in the inclining of the photosensitive medium, the photosensitive medium can be inclined to make the skewed scanning line and a longitudinal axis of the photosensitive medium parallel to each other.

In an exemplary implementation, in the inclining of the photosensitive medium, a plurality of photosensitive mediums for printing a color image can be connected to each other and inclined together to minimize bad color registration.

### BRIEF DESCRIPTION OF THE DRAWINGS

The above and other exemplary features and advantages of certain exemplary embodiments of the present invention will become more apparent from the following detailed description of certain exemplary embodiments thereof when taken in conjunction with the accompanying drawings, in which:

FIG. 1 illustrates scanning skew and image skew caused thereby;

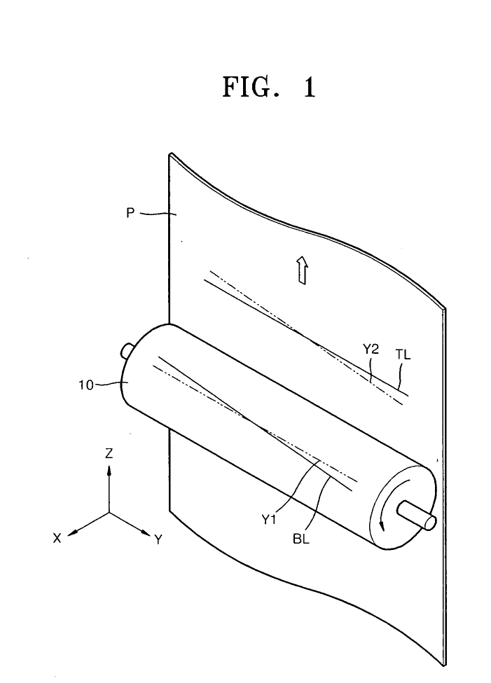

FIG. 2 is a cross-sectional view of an electro-photographic image forming apparatus according to an exemplary embodiment of the present invention;

FIG. 3 is a cross-sectional view of an image skew compensating apparatus included in the electro-photographic image forming apparatus of the exemplary embodiment of FIG. 2, according to an exemplary embodiment of the present invention;

FIG. 4 illustrates image skew compensation in the case of the image skew compensating apparatus of the exemplary embodiment of FIG. 3;

FIG. 5 is a cross-sectional view of the image skew compensating apparatus of the exemplary embodiment of FIG. 2 according to another exemplary embodiment of the present invention; and

FIG. 6 is a cross-sectional view of the image skew compensating apparatus of the exemplary embodiment of FIG. 2 according to another exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

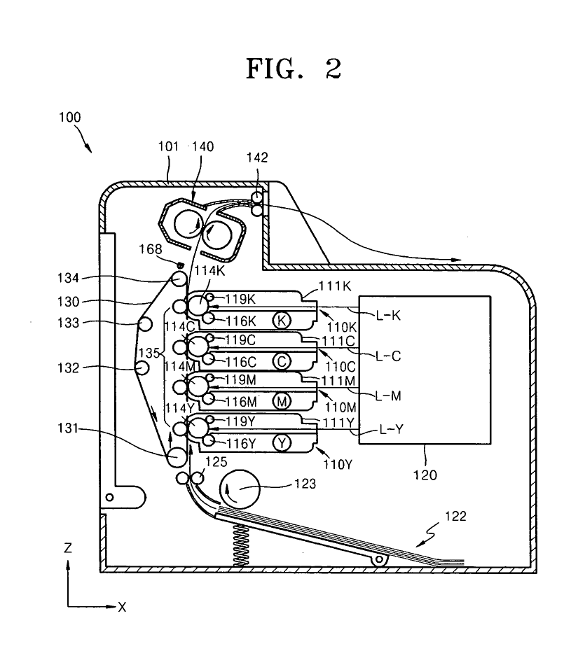

FIG. 2 is a cross-sectional view of an electro-photographic image forming apparatus 100 according to an exemplary embodiment of the present invention. Referring to FIG. 2, the electro-photographic image forming apparatus 100 comprises an electro-photographic color printer that can print a color image and includes a case 101, four developing units 110Y, 110M, 110C, and 110K, a laser scanning unit 120, a transfer belt 130, four transfer rollers 135, and a fixing unit 140. The image forming apparatus 100 further includes a cassette 122 in which paper P is stacked, a pickup roller 123 for picking up the paper P piece-by-piece from the cassette 122, a transportation roller 125 for transporting the picked-up paper P, and a discharging roller 142 for discharging the paper P outside of the case 101. The electro-photographic image forming apparatus 100 comprises a direct transfer type image forming apparatus in which a toner image is directly transferred from photosensitive mediums 114Y, 114M, 114C, and 114K to the paper P. The developing units 110Y, 110M, 110C, and 110K are of a cartridge type, and can be refilled or replaced when a developing agent, such as toner, stored therein is consumed. Toners of four colors such as yellow, magenta, cyan, and black are stored in the four developing units 110Y, 110M, 110C, and 110K, and are included in housings 111Y, 111M, 111C, and 111K, respectively.

The transfer belt 130 is supported by and circulates on a plurality of support rollers 131 through 134. The laser scanning unit 120 in the present exemplary embodiment scans light beams L-Y, L-M, L-C, and L-K onto the photosensitive mediums 114Y, 114M, 114C, and 114K, and is installed in the developing units 110Y, 110M, 110C, and 110K, respectively. Though not shown in FIG. 2, the laser scanning unit 120 includes a light source such as a laser diode (LD), a light deflector including a rotational multilateral mirror, an f-θ lens for correcting an aberration of light beams that are scanned and deflected, and a reflection mirror for refracting light toward the photosensitive mediums 114Y, 114M, 114C, and 114K. The photosensitive mediums 114Y, 114M, 114C, and 114K face the transfer belt 130 to transfer an image thereon. The developing units 110Y, 110M, 110C, and 110K include charging rollers 119Y, 119M, 119C, and 119K, and developing rollers 116Y, 116M, 116C, and 116K, respectively. A charge bias voltage is applied to the charging rollers 119Y, 119M, 119C, and 19K in order to charge the outer circumference of the photosensitive mediums 114Y, 114M, 114C, and 114K with a uniform potential. A developing bias voltage is applied to the developing rollers 116Y, 116M, 116C, and 116K to supply toner to the photosensitive mediums 114Y, 114M, 114C, and 114K.

Though not shown in FIG. 2, the developing units 110Y, 110M, 110C, and 110K further include supplying rollers supplying toner to the developing roller 116Y, 116M, 116C, and 116K, and doctor blades regulating the amount of toner attached on the developing rollers 116Y, 116M, 116C, and 116K, respectively, and agitators in the form of a conveyer belt transporting the toner to the supplying rollers. Additionally, openings are formed in the housings 111Y, 111M, 111C, and 111K of the developing units 110Y, 110M, 110C, and 110K to provide a path for the light beams L-Y, L-M, L-C, and L-K, scanned by the laser scanning unit 120 on the photosensitive mediums 114Y, 114M, 114C, and 114K, respectively.

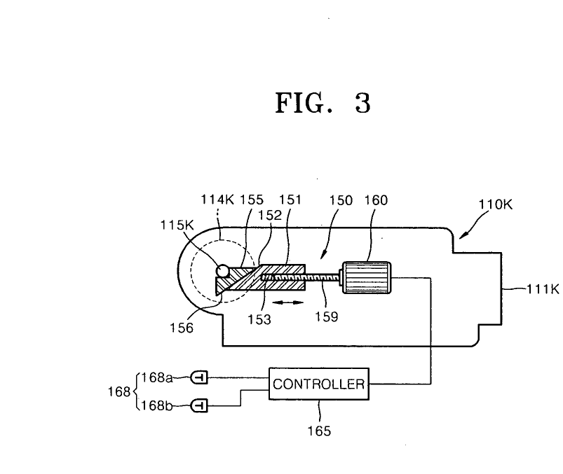

The four transfer rollers 135 are arranged to face the photosensitive mediums 114Y, 114M, 114C, and 114K, and the transfer belt 130 is disposed therebetween. Transfer bias voltages are applied to the transfer rollers 135. Also, a sensor 168 is placed in the upper portion of the transfer belt 130 to sense image skew of the toner image transferred to the paper P. The sensor 168 is a photosensor that radiates laser light to the transfer belt 130 and receives reflected laser light to check whether there is image skew and the amount of image skew. The sensor 168 includes a pair of photosensors 168a and 168b (see FIG. 3) to sense each end of the transfer belt 130 in the width direction. The sensor 168 senses image skew and simultaneously senses whether bad color registration occurs, and the amount thereof. Hereinafter, exemplary embodiments of the present invention providing a method of forming a color image by the above-described electro-photographic image forming apparatus will be presented.

Each of the photosensitive mediums 114Y, 114M, 114C, and 114K is charged with a uniform potential by charge bias voltages applied to the charging rollers 119Y, 119M, 119C, and 119K. The laser scanning unit 120 scans light beams L-Y, L-M, L-C, and L-K, corresponding to each color yellow, magenta, cyan, and black, onto the photosensitive mediums 114Y, 114M, 114C, and 114K. Thus, latent images are formed on the outer circumferences of the photosensitive mediums 114Y, 114M, 114C, and 114K. Developing bias voltages are then applied to the developing rollers 116Y, 116M, 116C, and 116K, thus toner is moved from the developing rollers 116Y, 116M, 116C, and 116K to the photosensitive mediums 114Y, 114M, 114C, and 114K and toner images of yellow, magenta, cyan, and black colors are developed on the outer circumferences of the photosensitive mediums 114Y, 114M, 114C, and 114K.

Meanwhile, paper P is picked up by the pick up roller 123 from the cassette 122 and put onto the transfer belt 130 by the transportation roller 125. The paper P is attached to the surface of the transfer belt 130 by an electrostatic force and transported at the same speed as the circulation speed of the transfer belt 130.

When the front end of a yellow toner image formed on the outer circumference of the photosensitive medium 114Y in the developing unit 110Y reaches a transfer nip facing the transfer roller 135, a front end of the paper P reaches the transfer nip. If a transfer bias voltage is applied to the transfer roller 135, then the yellow toner image formed on the photosensitive medium 114Y is transferred to the paper P. As the paper P is continuously transported, toner images of magenta, cyan, and black colors formed on the outer circumference of the photosensitive medium 114M, 114C, and 114K are sequentially overlapped and transferred to the paper P, thereby forming a color toner image on the paper P. The fixing unit 140 fixes the transferred color toner image to the paper P by heat and pressure. When fixing is completed, the paper P is discharged by the discharging roller 142 outside of the case 101.

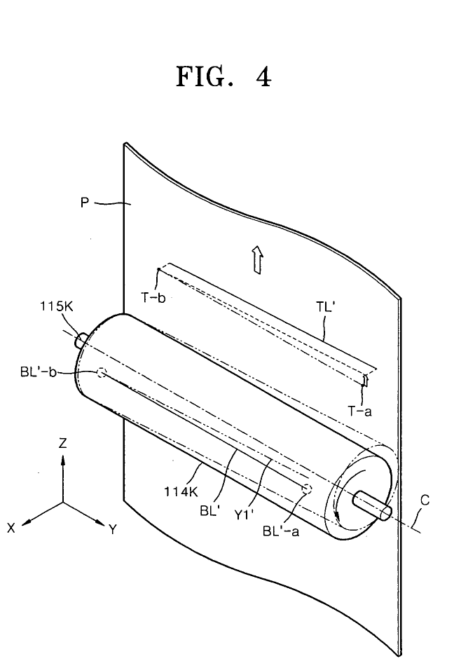

FIG. 3 is a cross-sectional view of an image skew compensating apparatus 150 included in the exemplary embodiment of the electro-photographic image forming apparatus of FIG. 2 according to an exemplary embodiment of the present invention. FIG. 4 illustrates image skew compensation performed by the image skew compensating apparatus 150 of the exemplary embodiment of FIG. 3. FIG. 3 illustrates a skew compensating apparatus for the black developing unit 110K; however the same image skew compensating apparatus 150 can be used for the developing units of other colors (110Y, 110M, and 110C). Additionally, four image skew compensating apparatuses 150 can be employed, each corresponding to the photosensitive mediums 114Y, 114M, 114C, and 114K, or eight image skew compensating apparatuses 150 may be employed for both ends of the photosensitive mediums 114Y, 114M, 114C, and 114K.

Referring to FIG. 3, the image skew compensating apparatus 150 includes a first inclination member 151 comprising a first inclined surface 152 facing upward and a second inclination member 155 comprising a second inclined surface 156 contacting and facing the first inclined surface 152 and supporting a shaft 115K at an end of the photosensitive medium 114K protruding to the outside of the housing 111K. The image skew compensating apparatus 150 includes a motor 160 and a screw 159 that extends from the rotation axis of the motor 160 and is inserted into a screw hole 153 in the first inclination member 151 in order to move the first inclination member 151 back and forth in a straight line.

The screw 159 has a threaded outer surface, and the screw hole 153 includes a threaded inner surface matching the outer surface of the screw 159. Thus, when the motor 160 is driven and the screw 159 rotates, the first inclination member 151 moves back and forth in a straight line according to the rotation direction of the screw 159. When the first inclination member 151 moves in a straight line, the second inclination member 155 rises and falls, thereby the shaft 115K at an end of the photosensitive medium 114K supported by the second inclination member 155 also rises and falls. Thus, the inclination of the photosensitive medium 114K is adjusted. In an exemplary implementation, the rise and fall of the shaft 115K at one end of the photosensitive medium 114K by the second inclination member 155 may be within 1 mm because if the inclination of the scanning line skew is above a certain degree, image skew cannot be effectively compensated for in spite of inclining the photosensitive medium 114K corresponding to the degree of the scanning line skew.

Referring to FIG. 4, a scanning line BL′ formed on the outer surface of the photosensitive medium 115K by the light beam L-K scanned by the laser scanning unit 120 (see FIG. 2) is obliquely scanned to a straight line Y1 that is parallel to the width direction of the paper P, that is, the Y-direction on the photosensitive medium 114K. When the photosensitive medium 114K is inclined such that the skewed scanning line BL′ and a single-dotted chain line C extending in the axial direction of the photosensitive medium 114K are parallel to each other, a toner line TL′ parallel to the Y-direction is formed in the Y-direction on the paper P proceeding upward in the Z-direction.

Toner T-a that is developed at an end BL′-a of the scanning line BL′ is transferred onto the paper P earlier than toner T-b developed at an end BL′-b. Since the photosensitive medium 114K is inclined, the toner T-a at the end BL′-a is transferred at a relatively low position and the toner T-b at the end BL′-b is transferred at a relatively high position. Accordingly, the paper P is elevated from the time the toner T-a is transferred onto the paper P until the time the toner T-b is transferred onto the paper P so that toners T-a and T-b at both ends are transferred at the same height on the paper P. Consequently, the horizontal toner line TL′ can be transferred onto paper P without being skewed despite the skewed scanning line BL′.

Referring to FIG. 3 again, the image skew compensating apparatus 150 includes a sensor 168 for sensing image skew, which has been described above with reference to FIG. 2, and a controller 165 for controlling driving of the motor 160 based on signals sensed by the sensor 168. Hereinafter, a method of compensating for image skew using the image skew compensating apparatus 150 will be described with reference to FIGS. 2 and 3.

The electro-photographic image forming apparatus 100 regularly stops image printing to transfer a scanning line for testing image skew or bad color registration. Bad color registration can occur when there is scanning line skew in only some of the light beams L-Y, L-M, L-C, and L-K. The toner line for testing is sensed by the sensor 168 and the controller 165 calculates the image skew and the degree thereof and bad color registration from the signals sensed by the sensor 168 and the height of rise and fall of the shaft 115K at an end of the photosensitive medium 114K to compensate for the image skew and the bad color registration. When the motor 160 is rotated in a certain direction and a certain amount in response to the driving signals of the controller 165, the first inclination member 151 moves a certain distance in a straight direction and the second inclination member 155 is elevated by being pushed by the inclination member 151 or moves downward due to its weight. Thus, the skewed scanning line BL′ (see FIG. 4) and the line C (see FIG. 4) become parallel to each other, and thus the image skew is corrected.

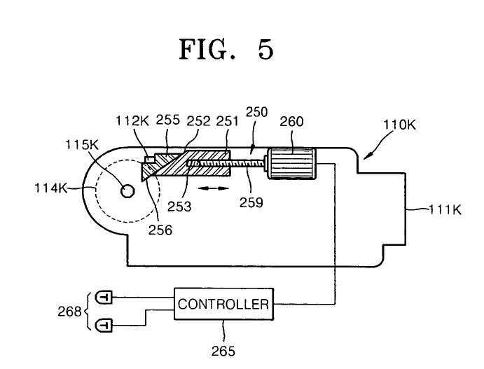

FIG. 5 is a cross-sectional view of another example of the image skew compensating apparatus of the exemplary embodiment of FIG. 2 according to another exemplary embodiment of the present invention. The image skew compensating apparatus 250 of FIG. 5 can be used instead of the image skew compensating apparatus 150 of FIG. 3 and can be included in the electro-photographic image forming apparatus 100. FIG. 5 illustrates the image skew compensating apparatus 250 for a black developing unit 110K; however the same image skew compensating apparatus 250 can be used for developing units of other colors (110Y, 110M, and 110C). Additionally, four image skew compensating apparatuses 250 can be used corresponding to the photosensitive mediums 114Y, 114M, 114C, and 114K, or eight image skew compensating apparatuses 250 can be formed for both ends of the photosensitive mediums 114Y, 114M, 114C, and 114K.

Referring to FIG. 5, the image skew compensating apparatus 250 includes a first inclination member 251 comprising an inclined surface 252 facing upward and a second inclination member 255 comprising a second inclined surface 256 contacting and facing the first inclined surface 252 and supporting a protrusion 112K formed at an end of the housing 111K of the developing unit 110K. The image skew compensating apparatus 250 further includes a motor 260 and a screw 259 that extends from the rotation axis of the motor 260 and is inserted in a screw hole 253 in the inclination member 251 in order to move the first inclination member 251 back and forth in a straight line. When the first inclination member 251 moves in a straight line, the second inclination member 255 rises and falls, thereby the protrusion 112K supported by the second inclination member 255 also rises and falls. Thus, the inclination degree of the photosensitive medium 114K on shaft 115K installed in the developing unit housing 111K is adjusted. The image skew compensating apparatus 250 also includes a sensor 268 for sensing image skew and a controller 265 for controlling driving of motor 260 based on signals sensed by the sensor 268. The method of compensating for image skew of the image skew compensating apparatus 250 is similar to the method of compensating for image skew of the image compensating apparatus 150 of FIG. 3. The second inclination member 255 supporting the protrusion 112K is elevated or moves downward by the straight-line motion of the first inclination member 252 and the photosensitive medium 114K installed in the developing unit housing 111K is inclined.

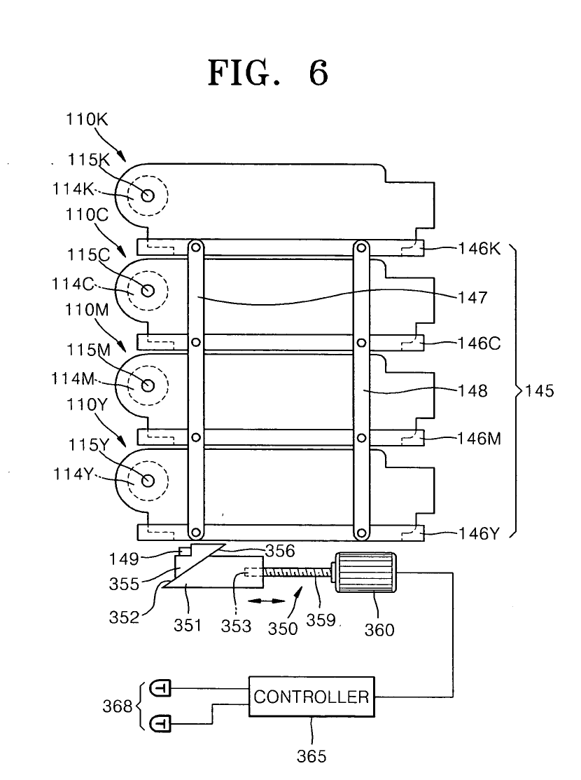

FIG. 6 is a cross-sectional view of another example the image skew compensating apparatus of the exemplary embodiment of FIG. 2 according to another exemplary embodiment of the present invention. The image skew compensating apparatus 350 of FIG. 6 can be used instead of the image skew compensating apparatus 150 or 250 of FIG. 3 or FIG. 4, and can be included in the electro-photographic image forming apparatus 100.

Referring to FIG. 6, in the electro-photographic image forming apparatus 100 (see FIG. 2), four developing units 110Y, 110M, 110C, and 110K are supported by a frame 145. The frame 145 includes four supporting plates 146Y, 146M, 146C, and 146K and a pair of links 147 and 148 linking these supporting plates 146Y, 146M, 146C, and 146K. Thus, the rise and fall of the developing units 110Y, 110M, 110C, and 110K at ends thereof, which are supported by the supporting plates 146Y, 146M, 146C, and 146K, are linked to each other. The image skew compensating apparatus 350 includes a first inclination member 351 comprising an inclined surface 352 facing upward and a second inclination member 355 comprising a second inclined surface 356 contacting and facing the first inclined surface 352 and supporting a protrusion 149 formed at an end of the frame 145. The image skew compensating apparatus 350 further includes a motor 360 and a screw 359 that extends from the rotation axis of the motor 360 and is inserted in a screw hole 353 in the inclination member 351 in order to move the first inclination member 351 back and forth in a straight line. When the first inclination member 351 moves in a straight line, the second inclination member 355 rises and falls, thereby the protrusion 149 supported by the second inclination member 355 also rises and falls. Thus, the inclination degree of the photosensitive mediums 114Y, 114M, 114C, and 114K, on shaft members 115Y, 115M, 115C, and 115K, installed in the developing units 110Y, 110M, 110C, and 110K, respectively, are collectively adjusted. The image skew compensating apparatus 350 includes a sensor 368 for sensing an image skew and a controller 365 for controlling driving of a motor 360 based on signals sensed by the sensor 368.

Hereinafter, exemplary embodiments of the present invention providing a method of compensating for image skew of the image skew compensating apparatus 350 will be described.

As described above, the electro-photographic image forming apparatus 100 (see FIG. 2) regularly stops image printing to transfer a scanning line to the transfer belt 130 for testing image skew or bad color registration. The toner line for testing is sensed by the sensor 368 and the controller 365 determines whether there is image skew or bad color registration by the signals sensed by the sensor 368. When image skew or bad color registration is determined, the controller 365 rotates the motor according to driving signals in a certain direction and a certain amount to elevate or make the protrusion 149 move down. Thus, the inclination degrees of the photosensitive mediums 114Y, 114M, 114C, and 114K are collectively changed. The photosensitive mediums 114Y, 114M, 114C, and 114K with a changed inclination are tested again to examine whether there is an image skew or bad color registration. This process is repeated and image skew compensation is finished when the image skew or bad color registration is minimized or is in an established allowable range.

According to exemplary embodiments of the present invention, image skew can be compensated for in a color image forming apparatus, and bad color registration can be corrected to improve printing quality.

Further, image skew can be compensated for even when it is difficult to incline the laser scanning unit.

In an exemplary implementation, the image skew compensating apparatus includes a sensor for sensing image skew and a controller for controlling driving of a motor to automatically compensate for the image skew.

While the present invention has been particularly shown and described with reference to certain exemplary embodiments thereof, it will be understood by those of ordinary skill in the art that various changes in form and detail may be made therein without departing from the spirit and scope of the present invention as defined by the following claims and equivalents thereof. For example, exemplary embodiments provide an implementation wherein an inclined surface of a first inclination member can be facing downward and an inclined surface of a second inclination member can be facing upward, or the second inclination member can be driven. Also, exemplary embodiments of the present invention can be applied to an indirect transfer type image forming apparatus in which a toner image developed in a photosensitive medium is transferred onto paper by an intermediate transfer medium or to an electro-photographic monochrome image forming apparatus that includes only one developing unit.

What is claimed is:

1. An image skew compensating apparatus for compensating for image skew of a toner image transferred onto paper, the image skew compensating apparatus comprising:
a first inclination member comprising a first inclined surface facing upward; and
a second inclination member comprising a second inclined surface contacting and facing the first inclined surface,
wherein a position of a shaft of a photosensitive medium onto which a light beam is scanned is adjusted by moving at least one of the first and second inclination members.

2. The apparatus of claim 1, further comprising:
a motor; and
a screw extended from a rotation axis of the motor and inserted into at least one of the first and second inclination members;
wherein a rotation of the screw moves at least one of the first and second inclination members back and forth according to the rotation direction of the motor.

3. The apparatus of claim 2, further comprising:
a sensor for sensing an image skew; and
a controller for controlling driving of the motor based on signals sensed by the sensor.

4. The apparatus of claim 1, wherein the second inclination member supports the shaft of the photosensitive medium.

5. The apparatus of claim 1, wherein the second inclination member supports one side of a developing unit comprising the photosensitive medium.

6. The apparatus of claim 1, wherein the second inclination member supports one side of a frame that links and supports a plurality of developing units, which respectively include a photosensitive medium.

7. The apparatus of claim 1, wherein a rise and fall of the photosensitive medium by moving at least one of the first and second inclination member is within 1 mm.

8. An electro-photographic image forming apparatus comprising:
at least one photosensitive medium on which an electrostatic latent image is formed by light beam scanning and a toner image is developed by toner supplied to the electrostatic latent image; and
an image skew compensating apparatus for compensating for image skew of a toner image transferred onto a paper by inclining the photosensitive medium,
wherein the image skew compensating apparatus comprises:
a first inclination member comprising a first inclined surface facing upward; and
a second inclination member comprising a second inclined surface contacting and facing the first inclined surface,
wherein a position of a shaft of the photosensitive medium is adjusted by moving at least one of the first and second inclination members.

9. The apparatus of claim 8, further comprising:
a motor; and
a screw extended from a rotation axis of the motor and inserted into at least one of the first and second inclination members; and
wherein a rotation of the screw moves at least one of the first and second inclination members back and forth according to the rotation direction of the motor.

10. The apparatus of claim 9, wherein the image skew compensating apparatus further comprises:
a sensor for sensing an image skew; and
a controller for controlling driving of the motor based on signals sensed by the sensor.

11. The apparatus of claim 8, wherein the second inclination member supports the shaft of the photosensitive medium.

12. The apparatus of claim 8, further comprising a developing unit in which the photosensitive medium is installed, wherein the second inclination member supports one side of the developing unit.

13. The apparatus of claim 8, further comprising:
a plurality of developing units comprising a plurality of photosensitive mediums, respectively; and
a frame for linking and supporting the developing units,
wherein the second inclination member supports one side of the frame.

14. The apparatus of claim 8, further comprising:
a plurality of photosensitive mediums; and
a plurality of the image skew compensating apparatuses corresponding to the number of the photosensitive mediums.

15. The apparatus of claim 8, wherein a toner image developed on the photosensitive medium is directly transferred to paper.

16. The apparatus of claim 8, wherein a toner image developed on the photosensitive medium is transferred to paper via an intermediate transfer medium.

17. The apparatus of claim 8, wherein a rise and fall of the photosensitive medium by moving at least one of the first and second inclination members is within 1 mm.

18. A method of compensating for image skew, the method comprising:
sensing image skew of a toner image; and
inclining a photosensitive medium onto which a light beam is scanned to correspond to scanning line skew of the light beam.

19. The method of claim 18, wherein the inclining of the photosensitive medium comprising inclining the photosensitive medium to make the skewed scanning line and a longitudinal axis of the photosensitive medium essentially parallel to each other.

20. The method of claim 18, wherein, the inclining of the photosensitive medium comprises inclining a plurality of photosensitive mediums for printing a color image.

21. The image skew compensating apparatus of claim 1 wherein the photosensitive medium onto which a light beam is scanned is inclined to be essentially parallel to a scanning line of the light beam.

22. The method of claim 20, wherein the photosensitive mediums are connected to each other and inclined together to minimize bad color registration.

23. A sensor for sensing an image skew in an image forming apparatus, the sensor comprising:
a first light emitting element for emitting a first light onto a first portion of a transfer belt of an image forming apparatus;
a second light emitting element for emitting a second light onto a second portion of the transfer belt;
a first light sensing element for sensing the first light reflected from the first portion of the transfer belt; and
a second light sensing element for sensing the second light reflected from the second portion of the transfer belt;
wherein the first portion of the transfer belt is spaced apart from the second portion of the transfer belt in a width direction of the transfer belt, and an output of the first and second light sensing elements comprises at least one of an indication of a skew of an image transferred by the transfer belt and an indication of color registration of the image.

24. The sensor of claim 23, wherein at least on of the first and second light sensing elements comprises a photosensor.

25. The sensor of claim 23, wherein:
the first light emitting element and the first light sensing element are positioned approximately in a vicinity of the first portion of the transfer belt;
the second light emitting element and the second light sensing element are positioned approximately in a vicinity of the second portion of the transfer belt; and
the first and second portions are at opposite ends of the transfer belt in the width direction of the transfer belt.

26. A method of sensing an image skew in an image forming apparatus, the method comprising:
emitting a first light onto a first portion of a transfer belt of an image forming apparatus;
emitting a second light onto a second portion of the transfer belt;
sensing the first light reflected from the first portion of the transfer belt;
sensing the second light reflected from the second portion of the transfer belt, wherein the first portion of the transfer belt is spaced apart from the second portion of the transfer belt in a width direction of the transfer belt; and
outputting based on the first and second sensed reflected light at least one of an indication of a skew of an image transferred by the transfer belt and an indication of color registration of the image.

27. The method of claim 26, wherein at least on of the first and second light sensing elements comprises a photosensor.

28. The method of claim 26, further comprising:
positioning the first light emitting element and the first light sensing element approximately in a vicinity of the first portion of the transfer belt; and
positioning the second light emitting element and the second light sensing element approximately in a vicinity of the second portion of the transfer belt;
wherein the first and second portions are at opposite ends of the transfer belt in the width direction of the transfer belt.

29. An image skew compensating apparatus for compensating for image skew of a toner image transferred onto an image recording medium, the image skew compensating apparatus comprising:
a sensor for sensing an image skew;
an inclination adjusting element for changing inclination of a photosensitive element onto which a light beam is scanned; and
a controller for controlling the inclination adjusting element based on the image skew sensed by the sensor.

30. The image skew compensating apparatus of claim 29, wherein the inclination adjusting element comprises:
a first inclination member comprising a first inclined surface facing upward; and
a second inclination member comprising a second inclined surface contacting and facing the first inclined surface,
wherein a position of a shaft of the photosensitive medium onto which the light beam is scanned is adjusted by moving at least one of the first and second inclination members.

31. The image skew compensating apparatus of claim 29, wherein the sensor comprises:
a first light emitting element for emitting a first light onto a first portion of a transfer belt of an image forming apparatus;
a second light emitting element for emitting a second light onto a second portion of the transfer belt;
a first light sensing element for sensing the first light reflected from the first portion of the transfer belt; and
a second light sensing element for sensing the second light reflected from the second portion of the transfer belt;
wherein the first portion of the transfer belt is spaced apart from the second portion of the transfer belt in a width direction of the transfer belt, and an output of the first and second light sensing elements comprises at least one of an indication of a skew of an image transferred by the transfer belt and an indication of color registration of the image.

32. A method for compensating for image skew of a toner image transferred onto an image recording medium, the image skew compensating apparatus comprising:
sensing an image skew; and
changing an inclination of a photosensitive element onto which a light beam is scanned based on the sensed image skew.

33. The method of claim 32, wherein the changing of the inclination comprises adjusting a position of a shaft of the photosensitive medium onto which the light beam is scanned.

34. The method of claim 33 wherein the adjusting comprises moving at least one of a first inclination member comprising a first inclined surface facing upward and a second inclination member comprising a second inclined surface contacting and facing the first inclined surface.

35. The method of claim 32, wherein the sensing of the image skew comprises:
emitting a first light onto a first portion of a transfer belt of an image forming apparatus;
emitting a second light onto a second portion of the transfer belt;
sensing the first light reflected from the first portion of the transfer belt; and
sensing the second light reflected from the second portion of the transfer belt;
wherein the first portion of the transfer belt is spaced apart from the second portion of the transfer belt in a width direction of the transfer belt, and an output of the first and second light sensing elements comprises at least one of an indication of a skew of an image transferred by the transfer belt and an indication of color registration of the image.

36. An image forming apparatus comprising:
at least one photosensitive medium on which an electrostatic latent image is formed by light beam scanning and a toner image is developed by toner supplied to the electrostatic latent image; and
an image skew compensating apparatus as claimed in claim 29 for compensating for image skew of a toner image transferred onto an image recording medium by inclining the photosensitive medium.

37. An image forming apparatus comprising:
a plurality photosensitive mediums on which an electrostatic latent image is formed by light beam scanning and a toner image is developed by toner supplied to the electrostatic latent image;
a sensor for sensing an image skew;
at least one inclination adjusting element for changing inclination of at least one of the plurality of photosensitive elements onto which a light beam is scanned; and
a controller for controlling the inclination of the at least one adjusting element based on the image skew sensed by the sensor.

38. The image forming apparatus of claim 37, further comprising a plurality of inclination adjusting elements for changing inclination of each of the plurality of respective photosensitive elements,
wherein the controller controls the inclination of at least one of the plurality of the adjusting elements based on the image skew sensed by the sensor.

39. The image forming apparatus of claim 38, wherein the controller controls the inclination of each of the plurality of the adjusting elements based on the image skew sensed by the sensor.

40. A method for forming and an image by an electro-photographic image forming apparatus, the method comprising:
forming an electrostatic latent image on a plurality photosensitive mediums by light beam scanning and developing a toner image by toner supplied to the electrostatic latent image;
sensing an image skew; and
changing inclination of at least one of the plurality of photosensitive elements onto which a light beam is scanned based on the sensed image skew.
